(19) United States
(12) Patent Application Publication
(10) Pub. No.: US 2026/0201194 A1
(43) Pub. Date: Jul. 16, 2026

(54) Composition for Sealing and Coating Edges and/or Chamfers of Wood-Based Panels

(71) Applicant: Flooring Technologies Ltd., Kalkara (MT)

(72) Inventors: Norbert Kalwa, Horn-Bad Meinberg (DE); Joachim Hasch, Berlin (DE); Andreas Gier, Mandelbachtal (DE)

(21) Appl. No.: 19/135,385

(22) PCT Filed: Dec. 1, 2023
(86) PCT No.: PCT/EP2023/083979

§ 371 Date: Jun. 4, 2025

(30) Foreign Application Priority Data
Dec. 5, 2022 (EP) 22211326.8

(51) Int. Cl. C09D 15/00; C09D 7/65; C09D 7/80; C09D 183/06

(52) U.S. Cl. CPC C09D 15/00; C09D 7/65; C09D 7/80; C09D 183/06

(57) ABSTRACT

A composition for sealing and coating at least one of edges and/or chamfers of wood-based panels, including a) at least one chamfer color, and b) at least one additive of at least one compound of the general formula (I) R¹ₐSiX¹₍₄₋ₐ₎, wherein X¹ is alkoxy-, aryloxy-, acyloxy-, and R¹ is an organic moiety selected from the group including alkyl, aryl, cycloalkyl, which may be interrupted by —O— or —NH—, and wherein R¹ has at least one functional group Q₁, which is selected from a group containing an acrylic, acryloxy, methacrylic, methacryloxy, cyano, isocyano and epoxide group, and a=0, 1, 2, 3, at least one compound of the general formula (II) R²_{b}SiX²_{(4-b)}, where X² is H or alkoxy-, aryloxy-, acyloxy, R² is a non-hydrolyzable organic moiety R² selected from the group including alkyl and aryl, and b=1, 2, 3, or 4, and at least one aqueous polymer dispersion.

### CROSS-REFERENCE TO RELATED APPLICATIONS

This application is the United States national phase of International Patent Application No. PCT/EP2023/083979 filed Dec. 1, 2023, and claims priority to European Patent Application No. 22211326.8 filed Dec. 5, 2022, the disclosures of each of which are hereby incorporated by reference in their entireties.

### BACKGROUND

### Technical Field

The present disclosure relates to a composition for coating and sealing edges and/or chamfers of wood-based panels, the use of this composition and wood-based panels with this composition.

### Technical Considerations

Floor panels with tongue and groove profiles on the side edges for laying to form panel assemblies, such as laminate flooring, are widely used and conventionally known. The tongue and groove profiles make it easy to lay flooring panels to form floor coverings. Such floor coverings can consist of wood fiber boards or plastic panels, for example. The floor panels are usually provided with a decorative layer and an abrasion-resistant surface layer.

Laminate flooring with so-called V-joints has proven to be very popular. These V-joints are formed with chamfers when laying flooring panels. The chamfers are angled cut-outs on the side edges of the flooring panels, which are painted with colored lacquers and give the laminate flooring a visual impression similar to parquet.

It is known that the product laminate flooring has a weak zone in the transition between the elements with regard to moisture attack or the occurrence of moisture damage, particularly after the changeover from elements glued together in tongue and groove to glueless installation. This damage can be caused by direct exposure to moisture, over-maintenance, etc. However, this problem is offset by the very simple and quick installation of this floor covering with the so-called click profiles. It can be assumed that well over 90% of laminate flooring today is produced with a click profile.

To date, various strategies have been used individually or in combination to reduce moisture damage. The simplest way to make it more difficult for moisture to penetrate the profile is to use the tightest possible fit in the tongue and groove joint. However, this can make it more difficult to join the elements or cause damage. This method also has the disadvantage that if water has penetrated the tongue and groove area, the wood-based material substrate will swell normally.

This effect can be enhanced by using a special press plate to create a compaction in the transition between the elements during direct coating. This is described in WO 2017/072657 A1. However, this only delays swelling and does not generally prevent it.

Another possibility is to seal the profile with hydrophobizing agents. WO 2006/038867, for example, describes the use of waxes to coat the edges, whereby at least partial penetration of the wax into the wood-based material can be observed. EP 903451 A2 describes the use of di-isocyanate diphenylmethane for treating the edges, which penetrates easily into the wood-based material. In WO 2008/078181 A1, a fluorinated polymer, e.g. perfluoroalkyl methacrylic copolymer, is again used as a coating agent, whereby the layer-forming material is solid at room temperature.

The main disadvantage of these known sealants is that they often migrate into the wood-based material carrier during application, thus minimizing the hydrophobic effect. However, this can also occur subsequently, so that the effect is slowly lost during use.

Another option is the use of swelling-tempered wood-based panels in which higher-quality glues (melamine-reinforced UF glues, PMDI, etc.) are used in production. A reduction in swelling can also be achieved by increasing the amount of glue. However, these options are the least favorable from a cost perspective, as increased quantities of glue and/or higher quality glues lead to a significant increase in the cost of the boards. They are also rather unfavorable from a recycling point of view.

Of the measures described, only the use of higher quality glues leads to a reduction in the swelling of the boards. The others merely cause a delay in the penetration of water in the profile area.

Accordingly, the known measures have various disadvantages. For example, the improvement in swelling protection is too small, the proposed measures cannot withstand some real stresses and the effects achieved are limited in time.

### SUMMARY

The present disclosure was therefore based on the object of overcoming the aforementioned disadvantages. The present disclosure was based on the technical object of producing a laminate floor which, by sealing the chamfer area, makes the profile impermeable to overlying water.

It should be possible to use the existing system technology. Preferably, the so-called NALFA test (24 h water application test, ISO 4760) should be passed. The aim of this test is to prevent water from penetrating the profile by taking suitable measures.

This approach has the advantage that wood fiberboards (MDF/HDF=fiberboard/fiberboard with increased bulk density) with increased amounts of glue or with higher quality glue systems do not have to be used as carrier materials, as in the best case no water penetrates the board. If possible, no solvents should be required for the system used. No chemically aggressive or environmentally harmful chemicals should be used either. Reactive systems (e.g., isocyanates), which can come into contact with the product surface through over-spray and react with it, should also not be used.

### DETAILED DESCRIPTION

According to the present disclosure, this object is solved by a composition having features as described herein.

Accordingly, a composition for sealing and coating edges and/or chamfers of wood-based panels is provided, the composition comprising:
a) at least one chamfer color, and
b) at least one additive from
   at least one compound of the general formula (I)

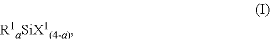

whereby
   X¹ is alkoxy-, aryloxy-, acyloxy-, and
   R¹ is an organic moiety selected from the group comprising alkyl, aryl, cycloalkyl, which may be interrupted by —O— or —NH—, and
   wherein R¹ comprises at least one functional group Q¹ selected from a group comprising an acrylic, acryloxy, methacrylic, methacryloxy, cyano, isocyano and epoxy group, and
   a=0, 1, 2, 3, in particular 0 or 1,
   at least one compound of the general formula (II)

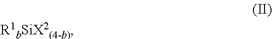

whereby
   X² is H or alkoxy-, aryloxy-, acyloxy,
   R² is a non-hydrolyzable organic moiety R² selected from the group consisting of alkyl and aryl, and
   b=1, 2, 3, or 4, and
   at least one aqueous polymer dispersion.

The composition according to the present disclosure has a viscosity (measured according to EN ISO 2431:2011, Coating materials—Determination of flow time with flow cups, 21° C.) with a flow time of 20 to 100 sec, preferably 30 to 80 sec, more preferably 35 to 60 sec over a period of at least 30 minutes, preferably of at least 60 minutes, more preferably of at least 120 minutes.

The composition according to the present disclosure is defined by its viscosity. The measurement method used here to determine the viscosity in accordance with EN ISO 2431:2011 requires the use of a measuring cup, whereby the viscosity is determined indirectly by the flow time of the composition from this measuring cup.

In some non-limiting embodiments, the viscosity can have the stated run-out times up to at least 24 h, 36 h or 72 h. A significant advantage of the present composition is that it is stable over a longer period of time (at least up to 72 h) and does not gel. This enables reliable reproducibility and applicability of the composition according to the present disclosure.

Although a composition for edge sealing comprising silanes and a polymer dispersion is known from EP 3 597 706 B1, it is unstable and gels after a short time. The differences in viscosity and stability result from the manufacturing process.

A combined use of a chamfer color with a sealing agent is carried out after profiling the floor panels. This mixture or composition is applied to the panel edges and/or milled chamfer in the existing application unit (application wheel or vacuum unit). After drying, this mixture effectively seals the profile and chamfer area against the penetration of water. It is advantageous that a combined application is carried out, thus avoiding the installation of an additional application unit and additional drying. The components can be mixed immediately before application to the edge and/or chamfer. This also makes it easy to change the components during production. Of course, this also applies to color changes.

The additive used in the present composition comprises the compound of the general formula (I) as a crosslinking component and the compound of the general formula (II) as a hydrophobic component. The crosslinking, hydrophilic component of the formula (I) enables, on the one hand, via the free —OH groups (present or formed by hydrolysis of, e.g., alkoxy groups), a bonding of the compound to the wood fibers and, on the other hand, the formation of a network. The hydrophobic component of formula (II)—formed, for example, from the alkyl groups of the residue R²—forms a water-repellent barrier. In this way, water cannot diffuse through the network of the formed coating.

The additive used in the present composition makes it possible to fill the pores present in the wood fiber board and to coat the wood fibers, thereby “sealing” them. On the other hand, the use of hydrophobic modifications creates a “hydrophobization” of the remaining pores and the still uncoated wood fibers.

The silane compounds are mixed with a suitable aqueous polymer dispersion in order to achieve the highest possible flexibility of the coating. The polymers used have functional groups that are compatible with the inorganic silane matrix. It is therefore possible to produce a coating with a high degree of cross-linking even at low temperatures.

The present composition can be used for any board systems and glue systems. The composition reduces swelling in wood fiber panels regardless of the glue systems used, different porosity or board thickness. For example, the swelling-reducing effect of the present composition has been demonstrated for HDF boards and chipboards with urea-formaldehyde glue (UF glue), melamine-urea-formaldehyde glue (MUF glue) or polyurethane-based glue (PMDI glue) or also for boards made of wood plastic composites (WPC).

The composition according to the present disclosure thus offers various advantages. For example, a significantly lower swelling of the edges is achieved, the composition does not penetrate or migrate into the panels, the composition can be used with any panel and glue systems and/or only relatively small application quantities are required. The composition according to the present disclosure prevents moisture from penetrating into the V-joints formed after laying floor panels.

In a non-limiting embodiment, the amount of additive in the present composition is 20 to 80 wt %, preferably 25 to 50 wt %.

In a non-limiting embodiment, the at least one chamfer color used in the present composition comprises color pigments and at least one solvent or suspending agent, for example an aqueous solvent or suspending agent. The color pigments used are carbon black, iron oxides, titanium dioxide and/or organic pigments. Suitable solvents or suspending agents are melamine-resin-formaldehyde resins or acrylates, with aqueous mixtures thereof being preferred. In a non-limiting embodiment, the chamfer color comprises color pigment, acrylate and water.

The moiety X¹ is advantageously selected from a group comprising C₁₋₆-alkoxy, for example methoxy, ethoxy, n-propoxy and butoxy, C₆₋₁₀-aryloxy, for example phenoxy, C₂₋₇-acyloxy, for example acetoxy or propionoxy, and the moiety X² is advantageously selected from a group comprising H, C₁₋₆-alkoxy, for example methoxy, ethoxy, n-propoxy and butoxy, C₆₋₁₀-aryloxy, for example phenoxy, C₂₋₇-acyloxy, for example acetoxy or propionoxy,

The organic moiety R¹ is preferably selected from a group comprising C₁-C₃₀-alkyl, for example C₅-C₂₅-alkyl, C₂-C₆-alkenyl, C₃-C₈-cycloalkyl and C₃-C₈-cycloalkenyl. In a non-limiting embodiment, the organic R¹ is selected from the group comprising methyl, ethyl, n-propyl, isopropyl, n-butyl, s-butyl, t-butyl, pentyl, hexyl, cyclohexyl, vinyl, 1-propenyl, 2-propenyl, butenyl, acetylenyl, propargyl, butadienyl or cyclohexadienyl, preferably methyl, ethyl, propyl or vinyl.

In a non-limiting embodiment of the present composition, the at least one functional group Q¹ is selected from a group comprising epoxy, methacrylic, methacryloxy, cyano and/or isocyano group. Accordingly, the functional group Q¹ can advantageously comprise a moiety having a double bond or an epoxide group which can be activated and polymerized by means of UV radiation.

In one variant of the present composition, compounds of the general formula (I) according to R¹ₐSiX¹₍₄₋ₐ₎, for example R¹SiX¹₃, with a functional group Q¹ may be selected from methacryloxypropyltrimethoxysilane (MPTS), aminoethyl-aminopropyltrimethoxysilane, silanes with an epoxy functionalization such as glycidyl-oxypropyltriethoxysilane, or silanes with a vinyl functionalization such as vinyltrimethoxysilane. e.g., vinyltrimethoxysilane.

As described, the moiety R¹ may have at least one functional group Q¹. In addition, the moiety R¹ may also be substituted with other moieties.

The term “substituted” denotes the substitution of one or more atoms, usually H atoms, by one or more of the following substituents, preferably by one or two of the following substituents: halogen, hydroxy, protected hydroxy, oxo, protected oxo, C₃-C₇-cycloalkyl, bicyclic alkyl, phenyl, naphthyl, amino, protected amino, monosubstituted amino, protected monosubstituted amino, disubstituted amino, guanidino, protected guanidino, a heterocyclic ring, a substituted heterocyclic ring, imidazolyl, indolyl, pyrrolidinyl, C₁-C₁₂-alkoxy, C₁-C₁₂-acyl, C₁-C₁₂-acyloxy, acryloyloxy, nitro, carboxy, protected carboxy, carbamoyl, cyano, methylsulfonylamino, thiol, C₁-C₁₀-alkylthio and/or C₁-C₁₀-alkylsulfonyl. The substituted alkyl groups, aryl groups, alkenyl groups, can be substituted once or several times and preferably once or twice, with the same or different substituents.

The term “aryl” as used herein refers to aromatic hydrocarbons, for example phenyl, benzyl, naphthyl, or anthryl. Substituted aryl groups are aryl groups which are substituted, as defined above, with one or more substituents as defined above.

The term “cycloalkyl” comprises the groups cyclopropyl, cyclobutyl, cyclopentyl, cyclohexyl and/or cycloheptyl.

In a preferred variant of the present composition, the compound of the general formula (I) corresponds to the formula SiX¹₄, wherein the moiety X¹ is alkoxy, for example methoxy, ethoxy, n-propoxy or i-propoxy. Tetramethoxysilane and tetraethoxysilane are used as preferred crosslinkers.

In a non-limiting embodiment of the present composition, the non-hydrolyzable organic moiety R² of the compound according to formula (II) is selected from a group comprising C₁-C₁₅-alkyl, for example C₁-C₁₀-alkyl, and/or C₆-C₁₀-aryl. These may be unsubstituted or substituted with a further hydrophobic group

It is preferred if the non-hydrolyzable organic moiety R² is selected from the group comprising methyl, ethyl, n-propyl, isopropyl, n-butyl, s-butyl, t-butyl, pentyl, hexyl, heptyl, octyl, nonyl, cyclohexyl, phenyl and/or naphthyl. Preferred are methyl, ethyl, propyl, octyl or phenyl moieties.

In the context of the present disclosure, the term “non-hydrolyzable organic moiety” is to be understood as an organic moiety which, in the presence of water, does not lead to the formation of an OH group or NH₂ group linked to the Si atom.

The compound of formula (II) may comprise one of the following formulae:
R²SiX²₃ with R² as C1-C10 alkyl group, preferably methyl, ethyl, propyl, pentyl, hexyl, heptyl, octyl, or as C6-C10 aryl group, preferably phenyl and with X² as alkoxy, for example methoxy, ethoxy, n-propoxy or i-propoxy, such as octyltriethoxysilane, phenyltriethoxysilane.

In one variant of the present composition, a compound of the general formula (I) and a compound of the general formula (II) are each used as an additive.

In a further variant of the present composition, however, at least one compound of the general formula (I) and at least two, preferably at least three compounds of the general formula (II) may also be present in the additive. Any combination is conceivable here.

Thus, the additive used in the present composition may have the following combinations:
at least one SiX¹₄, the moiety X¹ being alkoxy, for example methoxy, ethoxy, n-propoxy or i-propoxy, and at least one R²SiX²₃ with R² as C1-C10 alkyl group, preferably methyl, ethyl, propyl, pentyl, hexyl, heptyl, octyl, or as a C6-C10 aryl group, preferably phenyl, and with X² as alkoxy, for example methoxy, ethoxy, n-propoxy or i-propoxy, e.g., methyltriethoxysilane, octyltriethoxysilane, phenyltriethoxysilane; or
at least one SiX¹₄, the moiety X¹ being alkoxy, for example methoxy, ethoxy, n-propoxy or i-propoxy, and at least one R²SiX²₃ with R² as C1-C10 alkyl group, preferably methyl, ethyl, propyl, pentyl, hexyl, heptyl, octyl, e.g., methyltriethoxysilane, octyltriethoxysilane and at least one R²SiX²₃ with R² as C₆-C₁₀ aryl group, preferably phenyl and with X² as alkoxy, for example methoxy, ethoxy, n-propoxy or i-propoxy, such as, e.g., phenyltriethoxysilane, or
at least one SiX¹₄, the moiety X¹ being alkoxy, for example methoxy, ethoxy, n-propoxy or i-propoxy, and at least two R²SiX²₃ with R² as C₁-C₁₀ alkyl group, preferably methyl, ethyl, propyl, pentyl, hexyl, heptyl, octyl, or as a C₆-C₁₀ aryl group, preferably phenyl, and with X² as alkoxy, for example methoxy, ethoxy, n-propoxy or i-propoxy e.g., methyltriethoxysilane, octyltriethoxysilane and at least one R²Six²₃ with R² as C₆-C₁₀ aryl group, preferably phenyl and with X² as alkoxy, for example methoxy, ethoxy, n-propoxy or i-propoxy, such as, e.g., phenyltriethoxysilane.

Furthermore, in one variant, the composition may comprise tetraethoxysilane as a compound of formula (I) and methyltriethoxysilane and phenyltriethoxysilane as compounds of formula (II).

In another variant, the composition comprises tetraethoxysilane as a compound of the formula (I) and methyltriethoxysilane, phenyltriethoxysilane and octyltriethoxysilane as compounds of the formula (II).

In a non-limiting embodiment, the compound of the general formula (I) is present in the composition in a molar amount of 0.08 to 0.2 mol, preferably 0.1 to 0.15 mol, more preferably 0.1 to 0.12 mol, and the compound of the general formula (II) is present in a molar amount of 0.05 to 0.1 mol, preferably 0.06 to 0.09 mol, more preferably 0.07 to 0.08 mol.

The range of the molar amount indicated for the compound of the general compound (II) may refer to one compound or to the sum of two compounds or three compounds of the general formula (II)

Thus, the variant of the composition comprising tetraethoxysilane as a compound of formula (I) and methyltriethoxysilane and phenyltriethoxysilane as compounds of formula (II) may comprise 0.15 mol of tetraethoxysilane and 0.04 mol of methyltriethoxysilane/0.033 mol of phenyltriethoxysilane.

In the other variant of the composition comprising tetraethoxysilane as compound of formula (I) and methyltriethoxysilane, phenyltriethoxysilane and octyltriethoxysilane as compounds of formula (II), 0.1 mol of tetraethoxysilane and 0.03 mol of methyltriethoxysilane/0.025 mol of phenyltriethoxysilane and 0.043 mol of octyltriethoxysilane may be present.

The ratio of the silane compound of formula (I) to the silane compounds of formula (II) is preferably 1:0.5 to 1:2, preferably 1:0.75 to 1:1.5, most preferably 1:1 to 1:1.2.

In a non-limiting embodiment of the present composition, the at least one polymer is selected from the group comprising polyurethanes, epoxy resins; melamine resins, such as melamine-formaldehyde resin, and/or polyacrylates.

In the present case, the use of a polyurethane polymer is preferred, the polyurethane polymer being based on aromatic polyisocyanates, for example polydiphenylmethane diisocyanate (PMDI), toluene diisocyanate (TDI) and/or diphenylmethane diisocyanate (MDI), PMDI being preferred.

The polymer is incorporated into the network formed by the silane compounds and gives the composition flexible properties that facilitate application.

The type of polymer used is preferably matched to the silane compounds used. For example, it is advantageous to use silanes modified with epoxy groups together with epoxy polymers and silanes modified with methacrylate groups together with acrylate polymers.

In a non-limiting embodiment of the present composition, it is also possible to use more than one polymer.

In a non-limiting embodiment, the content of the polymer in the composition used herein is at least 30% by weight, preferably at least 20% by weight, more preferably at least 10% by weight.

In a non-limiting embodiment, the ratio of sol-gel to polymer is 1:0.1 to 1:0.5, preferably 1:0.2 to 1:0.4 (based on the solids).

The solvent content, which is essentially due to the use of the silanes, is 1 to 15% by weight, preferably 2 to 13% by weight, preferably 4 to 10% by weight. However, these FIGURES do not initially take into account the solvent content from the polymer used. Solvents are for example water and/or alcohols, here preferably ethanol. The alcohol content can be <1%, for example. It is also possible that the present composition contains only alcohol and little or no water, i.e., the silane compounds and also the polymer dispersion can be used in an alcoholic form.

In a non-limiting embodiment, the present composition may contain inorganic particles, for example SiO₂, Al₂O₃, ZrO₂, and/or TiO₂ particles. The particles preferably used have a size of 2 to 400 nm, preferably 2 to 100 nm, more preferably 2 to 50 nm. The addition of the inorganic particles increases the solids content of the composition, which improves the application behavior of the composition. The addition of inorganic particles also prevents shrinkage and cracking. The inorganic particles can be used in a quantity range of 0.1 to 25% by weight, preferably 5 to 20% by weight, based on the solids content of the silane material (sol-gel material).

Thus, the additive used in the present composition may have the following combinations:
at least one SiX¹₄, the moiety X¹ being alkoxy, for example methoxy, ethoxy, n-propoxy or i-propoxy, and at least one R²SiX²₃ with R² as C1-C10 alkyl group, preferably methyl, ethyl, propyl, pentyl, hexyl, heptyl, octyl, or as a C6-C10 aryl group, preferably phenyl, and with X² as alkoxy, for example methoxy, ethoxy, n-propoxy or i-propoxy, e.g. methyltriethoxysilane octyltriethoxysilane, phenyltriethoxysilane polyurethane and optionally SiO₂ particles; or
at least one SiX¹₄, the moiety X¹ being alkoxy, for example methoxy, ethoxy, n-propoxy or i-propoxy, and at least one R²SiX²₃ with R² as C1-C10 alkyl group, preferably methyl, ethyl, propyl, pentyl, hexyl, heptyl, octyl, e.g. methyltriethoxysilane, octyltriethoxysilane and at least one R²SiX²₃ with R² as C₆-C₁₀ aryl group, preferably phenyl and with X² as alkoxy, for example methoxy, ethoxy, n-propoxy or i-propoxy, e.g, phenyltriethoxysilane, polyurethane and optionally SiO₂ particles, or
at least one SiX¹₄, the moiety X¹ being alkoxy, for example methoxy, ethoxy, n-propoxy or i-propoxy, and at least two R²SiX²₃ with R² as C₁-C₁₀ alkyl group, preferably methyl, ethyl, propyl, pentyl, hexyl, heptyl, octyl, e.g. methyltriethoxysilane, octyltriethoxysilane and at least one R²SiX²₃ with R² as C₆-C₁₀ aryl group, preferably phenyl and with X² as alkoxy, for example methoxy, ethoxy, n-propoxy or i-propoxy, e.g, phenyltriethoxysilane, polyurethane and optionally SiO₂ particles.

A preferred variant of the present composition comprises tetraethoxysilane, methyltriethoxysilane, phenyltriethoxysilane, octyltriethoxysilane and polyurethane and optionally SiO₂ particles. A preferred variant of the present composition comprises tetraethoxysilane, methyltriethoxysilane, phenyltriethoxysilane, octyltriethoxysilane, polyurethane and SiO₂ particles.

According to a first non-limiting embodiment, the present composition is preparable in a process comprising the following steps:
providing at least one dispersion A) comprising polymer dispersion and optionally a dispersion of inorganic particles,
providing a solution B) comprising a mixture of at least one compound of the general formula (I), at least one compound of the general formula (II) and at least one catalyst, for example an acid,
adding the solution B) to the dispersion A) and neutralization of the additive mixture (e.g. by adding a basic compound);
separating the aqueous phase of the additive from polymer dispersion, at least one compound of the formula (I) and at least one compound of the formula (II), and
adding the additive to the at least one chamfer color.

The present composition is also preparable according to a second non-limiting embodiment in a process comprising the following steps:
providing a solution C) comprising a mixture of at least one compound of the general formula (I), at least one compound of the general formula (II) and at least one polymer dispersion (an ion exchanger);
providing a solution D) comprising at least one compound of the general formula (II) and at least one catalyst, for example an acid,
stirring solution D) into solution C);
separating the aqueous phase of the additive from at least one compound of formula (I), at least two compounds of formula (II) and polymer dispersion; and
adding the additive to the at least one chamfer color.

Suitable inorganic and/or organic acids as catalysts are selected from a group comprising phosphoric acid, acetic acid, p-toluenesulfonic acid, hydrochloric acid, formic acid and/or sulfuric acid. Also suitable are ammonium salts such as ammonium sulphate, which react as weak acids. p-Toluenesulphonic acid is preferred.

A basic compound, such as ammonia or NaOH, is preferably added for subsequent neutralization of the reaction mixture. This leads to a separation of the aqueous phase with the binder content from the alcoholic phase (ethanolic phase). The aqueous phase can then be easily separated from the alcoholic phase.

In the case where inorganic particles are added to the binder composition, the inorganic particles are preferably used in an amount of 0.1 to 15 wt %, preferably 0.5 to 10 wt %, more preferably 1 to 5 wt %.

As mentioned above, the present composition can be used for coating or sealing edges and/or chamfers of wood-based panels, for example WPC, particleboard, HDF and/or MDF panels.

The problem underlying the present disclosure is also solved by a wood-based panel with the present composition.

Accordingly, at least one wood-based panel, such as HDF or MDF board or chipboard, comprises at least one composition according to the present disclosure, with which for example the edges and/or chamfers of the wood-based panel are coated for the purpose of sealing.

The composition can be applied to the edges and/or chamfers of the wood-based panel, e.g. by spraying, rolling or using a vacuum.

The layer thickness of the composition on the panel edge and/or chamfer can be in a range of 10 to 50 μm, preferably 20 to 40 μm.

The composition can be applied to the panel edges and/or chamfers in a liquid application with a quantity of 100 to 200 silane fl.g/m², preferably 120 to 150 silane fl.g/m². This results in a solid content on the panel edge of 5 to 25 mg/cm², preferably 10 to 20 mg/cm².

Wood-based panels, such as wood chipboard and wood fiberboard, e.g., MDF, HDF boards, are made from wood chips or wood fibers obtained by chipping the wood chips in a chipper or a refining process of the wood chips in a refiner. The wood fibers used in wood fiberboards have a length of 1.5 mm to 20 mm and a thickness of 0.05 mm to 1 mm. The size of wood chips used in particleboard depends on whether they are used in the top or middle layer. In the middle layer, the chips start at >0.125 mm screen width, in the top layer at >0.8-1.0 mm.

The present wood-based panels can have various binder systems, which are mixed and pressed with the wood fibers as a binder. Preferred binder systems are: formaldehyde resins, such as urea-formaldehyde resins, melamine-formaldehyde resins, melamine-urea-formaldehyde resins; polyurethanes, preferably based on polydiphenylmethane diisocyanate (PMDI), epoxy resin and/or polyester resins.

The present wood-based panels can also have a coating on the top side of the panel with films, e.g., films made of thermoplastic materials such as PVC or PP, or paper impregnates, such as impregnates made of decorative paper layers or overlay papers. Overlay, decorative, backing and kraft paper impregnates are based on thin layers of paper that are completely or partially impregnated with a resin, preferably melamine-formaldehyde resin.

Impregnations can be applied, for example, in an impregnation bath, by rolling, by screen rolling, by doctoring or by spraying. In a non-limiting embodiment, the paper layers are treated as follows: First, the paper layer is impregnated on the reverse side (e.g. in a soaking tub) with a resin with a solids content of 50 to 70% by weight, preferably 60% by weight. After passing through a breathing section, dip impregnation with a resin takes place. Excess resin is removed in a doctor blade system/squeegee roller pair, and optionally (in the case of an overlay paper layer) abrasion-resistant particles are scattered onto the impregnated paper layer. This is followed by a drying step to a residual moisture content of approx. 6%.

In the case of coated wood-based panels, these papers (decor, overlay) are applied to the wood-based panels and pressed. Typically, the impregnated decor paper is first applied to the top of the wood-based panel. The decorative impregnate is then followed by at least one overlay impregnate. The overlay impregnate is pressed onto the underside of the wood-based panel. A typical structure of a coated HDF board is from top to bottom: Overlay impregnate, decorative impregnate, HDF substrate, backing impregnate.

In a non-limiting embodiment, it is also intended to apply a veneer to a wood-based panel. Such veneers typically have a surface finish consisting of a coating based on UV or ESH lacquers.

The veneers are glued onto the wood-based panel (HDF, chipboard, OSB, etc.). Urea or PVAc glues with hardener are usually used to glue the veneers to the substrate.

It is also possible to press the veneer onto the wood-based panel in a short-cycle press using a paper impregnated with melamine resin (e.g., an overlay). The pressing parameters are approx. T>150° C., p>30 bar and t>30 sec. This technology can also be used to produce veneer flooring with veneers that are approx. 0.5 mm thick. It is crucial that the melamine resin rises as far as possible into the veneer during the pressing process. On the one hand, this reinforces the veneer with the synthetic resin and, on the other hand, the veneer compressed by the pressing process is fixed in this state. However, the melamine resin should not escape from the veneer, as this would lead to discoloration of the surface and adhesion problems during subsequent varnishing or oiling.

In a non-limiting embodiment, a chipboard pressed with a veneer is used. For this purpose, in a first step, a resin-impregnated paper (preferably a resin-impregnated kraft paper) with a veneer is placed on a chipboard (e.g., on the top side) and pressed. In a further variant, a resin-impregnated paper and/or a veneer are used as a backing.

It is also possible for the wood-based panel to be coated with liquid resin layers (liquid coating) and pressed. In this process, a base coat layer is first applied to the wood-based panel, followed by a primer layer, which is then printed to form a decorative layer. Further resin layers are then applied to the decorative layer as protective and wear layers. The wood-based panel can accordingly have at least one decorative layer on the top side and a multi-layer resin structure containing abrasion-resistant particles, cellulose fibers and glass beads. The following layer structure is possible (viewed from bottom to top): Backing consisting of six resin layers—wood-based panel—base coat layer—print decoration layer—protective layer, for example a protective layer consisting of a resin that has not yet fully cured—first resin layer with cellulose fibers-layer of abrasion-resistant particles—second resin layer—third resin layer with glass beads-fourth resin layer with glass beads—fifth resin layer with glass beads—sixth resin layer (without glass beads). The protective layer serves to cover the decoration and to protect the decoration during intermediate storage (stacking, storage, transportation). The other resin layers on the top side together form an overlay that protects the finished laminate against abrasion and enables decor-synchronous structuring.

In the case of the use of the wood-based panels described as floor panels, the wood-based panels are provided with a tongue-and-groove interlock and used for floating installation. A corresponding installation method comprises laying a first floor panel and attaching a second floor panel to the first floor panel, wherein the tongue of the second floor panel is inserted into the groove of the first floor panel.

The chamfered floor panels form V-joints after installation, which are sealed and protected from moisture penetration by the applied composition of chamfer paint and additive.

The present disclosure is explained in more detail below with reference to examples of non-limiting embodiments.

### Example 1: Preparation of a Sealing Composition According to a First Process Variant

### Production of Dispersion A)

28.8 g of an aqueous SiO₂ dispersion (Köstrosol 3550) and 20 g of an aqueous polyurethane solution Alberdingk U 3215 are added.

### Production Solution B)

In parallel, 12.3 g ocyltriethoxysilane, 2.4 g methyltriethoxysilane, 6.1 g phenyltriethoxysilane, 20.8 g tetraethoxysilane and 28.8 g water are heated to 50° C. and stirred, then 2.8 g sulphuric acid is added and stirred for 120 minutes. This solution is then stirred into the above suspension while still warm and stirred at room temperature for a further 60 minutes. A 0.1 molar NaOH solution is added until a pH value of 7.5 is reached.

After standing for 24 hours, the alcoholic phase is separated using a separating funnel.

The additive can now be added to a commercially available chamfer color up to 50% by weight, which remains stable for several weeks. Curing after application takes place thermally (e.g. 100° C., 5 minutes).

### Example 2: Preparation of a Sealing Composition According to a Second Process Variant

### Production Solution C)

After 6.1 g phenyltriethoxysilane and 20.8 g tetraethoxysilane have been added and 7.2 g demineralized water and 0.8 g Lewatit 2629 ion exchanger have been added, the mixture is stirred at 60° C. for 3 hours. The ion exchanger is then removed again via filtration and 12 g of water and 17 g of an aqueous polyurethane solution Alberdingk U 3215 are added in a further step.

### Production Solution D)

parallel, 12.3 g of ocyltriethoxysilane, 2.4 g of methyltriethoxysilane and 2.4 g of sulphuric acid (1 molar) are added with 20 g of water and hydrolyzed at 55° C. for 4 hours. After cooling to room temperature, solution B is stirred into solution A and stored for 8 hours without stirring. Two phases are formed, which are now separated using a separating funnel.

The additive can now be added to a commercially available chamfer color up to 50% by weight, which remains stable for several weeks. Curing after application takes place thermally (e.g. 100° C., 5 minutes).

### Example 3: Comparison of the Composition According to Example 1 and a Composition According to EP 3 597 706 B1

### Composition According to EP 3 597 706 B1

The chamfer varnish used has a flow time (4 mm nozzle) of 36 seconds at 21° C. (measured in accordance with EN ISO 2431:2011 “Coating materials-Determination of flow time with flow cups”). Additive “A” according to the example from EP 3 597 706 B1 has a flow time of 11 seconds.

The addition of 25% by weight of “A” to the chamfer varnish resulted in a flow time of the mixture of 60 seconds. After a waiting time of 60 minutes, this increases to 140 to 150 seconds. After a further 60 minutes waiting time, measurement is no longer possible as the mixture has gelled.

The addition of 50% by weight of “A” to the chamfer varnish resulted in a flow time of the mixture of 120 seconds. After a waiting time of 60 minutes, the mixture was gelled.

### Composition According to Embodiment 1

The chamfer varnish used also has a flow time (4 mm nozzle) of 36 seconds at 21° C. Additive “B” according to embodiment example 1 has a flow time of 13 seconds

The addition of 25% by weight of “B” to chamfer varnish resulted in a flow time of the mixture of 40 seconds. After a waiting time of 60 minutes, the flow time remained at 40 seconds. No increase after a further 60 minutes waiting time. Not even after 72 hours

The addition of 50% by weight of “B” to chamfer varnish resulted in a flow time of the mixture of 40 seconds. After a waiting time of 60 minutes, the flow time remained at 40 seconds. No increase after a further 60 minutes waiting time. Not even after 72 hours.

### Example 4

A 7.4 mm HDF with a bulk density of approx. 850 kg/m³, which had been produced with a urea-formaldehyde glue in a standard quantity, was coated on the top side with an overlay (AC4) and a decorative impregnate and on the underside with a counter-impregnate in a KT press under pressure and temperature (p=40 bar, T=200° C., t=15 sec). The boards are transferred to a maturing store for cooling and after three days are cut into raw boards on a flooring line. They were then provided with a glueless profile (see picture), which gave a negative result in the NALFA test in approx. 80% of the tests. This was a glueless profile without additional plastic locking agents. The chamfer was coated with a mixture of chamfer color and silane additive according to example 1 (application quantity: 1.0 g fl./lfm, solids content: approx. 42%). The mixture applied to the chamfer was dried using an IR lamp. For comparison, planks were produced with chamfer color only.

### Example 5

A 7.4 mm HDF with a bulk density of approx. 850 kg/m³, which had been produced with a urea-formaldehyde glue in a usual quantity, was provided with the following material applications on the top side in a production line, with intermediate drying following each application:
Melamine primer (20 g melamine resin fl./m² (solids content: 55% by weight) with drying
Color base coat white (multiple application total: 25 g white base coat fl./m² (solids content: approx. 50% by weight) with intermediate drying
Primer (10-20 g fl./m²) with drying
Printing (indirect gravure or digital printing)
Melamine covering (approx. 20-30 g melamine resin fl./m², solids content: approx. 65% by weight with approx. 10-20% glass beads based on liquid resin)

The pre-coated HDF was then provided with the following material applications in a further production line:
Melamine resin application on top (approx. 60-80 g melamine resin fl./m², solids content: 55% by weight)
Scattered application of corundum (20-30 g corundum/m², F220 according to FEPA standard)
Multiple melamine resin application on top with drying (5 coats): Total application: 60-80 g melamine resin fl./m², solids content: approx. 55% by weight, 3rd application with 10-20% by weight glass beads)
Multiple melamine resin application below with intermediate drying (3 coats): Total application: 140-160 g melamine resin fl./m²m solids content; approx. 55% by weight)

The formulations contain the necessary additives such as hardeners, wetting agents and release agents.

This structure is then coated in a KT press under pressure and temperature (p=40 bar, T=200° C., t=15 sec). The boards are transferred to a maturing store for cooling and after three days are cut into raw boards on a flooring line. They were then provided with a glueless profile (see picture), which gave a negative result in the NALFA test in approx. 80% of the tests. This was a glueless profile without additional plastic locking agents. The chamfer was coated with a mixture of chamfer color and according to example 1 (application quantity: 1.0 g fl./lfm, solids content: approx. 42%). The mixture applied to the chamfer was dried using an IR lamp. For comparison, planks were produced with chamfer color only.

### Example 6: NALFA Test (ISO 4760)

The planks produced in examples 4 and 5 were used to produce test surfaces (10 per variant) in accordance with ISO 4760. The ring glued to the surface was filled with 100 ml of colored water. The water remains on the surface for 24 hours. An assessment is then carried out in accordance with the standard. This includes not only the determination of the residual amount of water still present in the ring, but also a determination of the swelling of the test specimens in the test area. The results are summarized in the following table.

| | | Thickness | Result |
|---|---|---|---|
| Example | Sample designation | in mm | NALFA test |
| | Zero sample | 7.4 | 8 out of 10 samples |
| | chamfer color | | failed |
| 4 | Direct coating with | 7.4 | 10 out of 10 samples |
| | chamfer color/silane | | passed |
| 5 | Direct printing/direct | 7.4 | 10 out of 10 samples |
| | coating with chamfer | | passed |
| | color/silane | | |

The same procedure was applied to other glueless profiles (with and without plastic locking agents) that performed negatively in the NALFA test. There was always a clear improvement in the NALFA test. The pass rate for all variants was greater than 90%.

### Example 7: Water-Resistant Chipboard with Veneer Surface and Sealant

The base materials are explained below. As an alternative to the paper backing (alternative I), a veneer backing (alternative II) can also be used. The veneer for the backing can be of the same or different, or simpler, quality as the veneer for the top side.

### Veneer for the top:

Thickness: 0.6 mm
Species: Oak
   Paper: Synthetic resin impregnated kraft paper
Paper weight: 25 g/m²
Resin application: 600%
Synthetic resin: Melamine resin
   Water-resistant chipboard: thickness 7.8 mm

### Backing:

I Paper: Synthetic resin impregnated kraft paper
Paper weight: 25 g/m²
Resin application: 600%
Synthetic resin: Melamine resin
   II Veneer thickness 0.6 mm
Species: Poplar

### Production of the Resin-Impregnated Paper:

The paper is passed through a bath of liquid synthetic resin, in this case melamine resin. In the bath, the paper is impregnated or soaked with liquid synthetic resin. After impregnation or soaking, excess synthetic resin is removed by a scraper so that there is only a layer of synthetic resin on the upper side of the now resin-impregnated paper. The top side of the resin-impregnated paper consists of synthetic resin, in this case: melamine resin. The amount of synthetic resin used can be varied. However, it is preferably measured in such a way that the applied veneer penetrates at least ⅔ of the veneer thickness during subsequent pressing by the synthetic resin liquefied in the press. It is further preferred that the veneer is compressed in the press. According to a non-limiting embodiment, the veneer is thus impregnated with synthetic resin to at least ⅔, preferably completely, after completion of the pressing process. Swelling and shrinkage of the veneer is thus largely reduced.

The impregnated paper is dried to a residual moisture content of 5% to 6%, for example. The resin application of the 25 g/m² paper was 600% based on the weight of the paper. Drying takes place, for example, in a channel dryer, in which hot air nozzles flow onto the paper from the top and underside and thus dry it, but the synthetic resin is not cured. The dried, resin-impregnated paper can now be stored until it is used.

The resin-impregnated paper for the backing can be produced in the same way as described above. The resin-impregnated paper for the backing is also dried to a VC value of, e.g., 6%. The veneer for the backing can be prepared and subsequently processed in the same way as the veneer for the top side.

### Production of the Veneered Panel:

The backing, carrier board, synthetic resin-impregnated paper and veneer are layered to form a stack of pressed material, with the top side of the synthetic resin-impregnated paper facing the top side of the water-resistant chipboard and the bottom side facing the veneer. The stack of pressed material is placed in a KT press (short-cycle press) and pressed there at a temperature of 180° C. and a pressure of p=30 N/mm² for a pressing time of 60 seconds.

It can be pressed with a simple, smooth press plate. In this embodiment example, however, textured press plates can also be used as texturing elements. For example, a press plate with a wood structure can be used. The wood structure of the press plate is then recognizable in the veneer, which may differ from the wood structure of the veneer. No recognizable melamine resin layer had formed on the top of the veneer. The coated waterproof chipboard was then optionally finished with a UV varnish with an application quantity of 50 g/m² to 100 g/m² or with a UV oil with an application quantity of 20 g/m² to 40 g/m² on the surface. The application quantities are based on the desired usage class. Corundum can optionally be incorporated into the UV coating, especially if higher usage classes with improved abrasion resistance are to be achieved.

The veneer surface on the top side is thus accentuated or designed in a way that was previously not possible. The reverse side of the waterproof chipboard can be left as it is, especially if a veneer has been applied in accordance with alternative II, or alternatively impact sound insulation can be subsequently laminated on, for example.

The large format is then first cut on a flooring line to form unfinished fixed masses and then milled into profiled planks. These planks can be fitted with or without a chamfer.

The chamfer or the straight veneer edge is coated with a mixture of chamfer color and silane additive according to example 1 (application quantity: 1.0 g fl./lfm, solids content: approx. 42%). The application is dried using an IR lamp.

1. A composition for sealing and coating edges and/or chamfers of wood-based panels comprising
a) at least one chamfer color comprising color pigments and at least one aqueous solvent, and
b) at least one additive from
at least one compound of the general formula (I) 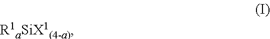
whereby
X¹ is alkoxy-, aryloxy-, or acyloxy-, and
R¹ is an organic moiety selected from the group comprising alkyl, aryl, and/or cycloalkyl, which may be interrupted by —O— or —NH—, and
wherein R¹ comprises at least one functional group Q¹ selected from a group comprising an acrylic, acryloxy, methacrylic, methacryloxy, cyano, isocyano and/or epoxy group, and
a=0, 1, 2, 3,
at least one compound of the general formula (II) 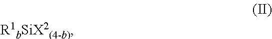
whereby
X² is H or alkoxy-, aryloxy-, or acyloxy,
R² is a non-hydrolyzable organic moiety R² selected from the group consisting of alkyl and aryl, and
b=1, 2, 3, or 4, and
at least one aqueous polymer dispersion,
wherein the composition has a viscosity (measured according to EN ISO 2431:2011, 21° C.) with a run-out of 20 to 100 sec over a period of at least 30 minutes.

2. The composition according to claim 1, wherein the additive is present in an amount of 20 to 80% by weight.

3. The composition according to claim 1, wherein the at least one chamfer color comprises color pigments and an aqueous melamine-resin-formaldehyde suspension.

4. The composition according to claim 1, wherein at least one compound of the general formula (I) and at least two compounds of the general formula (II) are present.

5. The composition according to claim 1, wherein X¹ is selected from a group comprising C₁₋₆-alkoxy, C₆₋₁₀-aryloxy and/or C₂₋₇-acyloxy, and X² is selected from a group comprising H, C₁₋₆-alkoxy, C₆₋₁₀-aryloxy and/or C₂₋₇-acyloxy.

6. The composition according to claim 1, wherein the compound of the general formula (I) corresponds to the formula SiX¹₄.

7. The composition according to claim 1, wherein the non-hydrolyzable organic R² is selected from a group comprising C₁-C₁₅-alkyl and/or C₆-C₁₀-aryl.

8. The composition according to claim 1, wherein non-hydrolyzable organic R² is selected from the group comprising methyl, ethyl, n-propyl, isopropyl, n-butyl, s-butyl, t-butyl, pentyl, hexyl, heptyl, octyl, nonyl, cyclohexyl, vinyl, 1-propenyl, 2-propenyl, butenyl, acetylenyl, propargyl, phenyl and/or naphthyl.

9. The composition according to claim 1, wherein the compound of formula (II) comprises one of the following formulae:
R²₄Si with R² as C1-C5 alkyl group,
R²₃Six² with R² as C1-C5 alkyl group, and with X² as H,
R²SiX2₃ with R² as C1-C10 alkyl group, or as C6-C10 aryl group and with X² as alkoxy.

10. The composition according to claim 1, wherein the at least one polymer of the polymer dispersion is selected from the group comprising polyurethanes, epoxy resins, melamine resins and/or polyacrylates.

11. The composition according to claim 1, wherein inorganic particles may be present.

12. The composition according to claim 1, preparable in a process comprising:
providing at least one dispersion A) comprising polymer dispersion,
providing a solution B) comprising a mixture of at least one compound of the general formula (I), at least one compound of the general formula (II) and at least one catalyst,
adding solution B) to dispersion A) and neutralization of the additive mixture (addition of a basic compound),
separating the aqueous phase of the additive from polymer dispersion, at least one compound of the formula (I) and at least one compound of the formula (II), and
adding the additive to the at least one chamfer color.

13. The composition according claim 1, preparable in a process comprising:
providing a solution C) comprising a mixture of at least one compound of the general formula (I), at least one compound of the general formula (II) and at least one polymer dispersion (an ion exchanger);
providing a solution D) comprising at least one compound of the general formula (II) and at least one catalyst;
stirring solution D) into solution C);
separating the aqueous phase of the additive from at least one compound of formula (I), at least two compounds of formula (II) and polymer dispersion; and
adding the additive to the at least one chamfer color.

14. The composition according to claim 1, wherein the wood-based panels are chipboards, HDF panels or MDF panels.

15. A wood-based panel comprising at least one composition applied to an edge and/or chamfer according to claim 1.

16. The composition according to claim 1, wherein the composition has a viscosity (measured according to EN ISO 2431:2011, 21° C.) with a run-out time of 30 to 80 sec over a period of at least 30 minutes.

17. The composition according to claim 1, wherein the composition has a viscosity (measured according to EN ISO 2431:2011, 21° C.) with a run-out time of 20 to 100 sec over a period of at least 60 minutes.

18. The composition according to claim 2, wherein the additive is present in an amount of 25 to 50% by weight.

19. The composition according to claim 4, wherein at least one compound of the general formula (I) and at least three compounds of the general formula (II) are present.
